(19) United States
(12) Patent Application Publication
(10) Pub. No.: US 2013/0276844 A1
(43) Pub. Date: Oct. 24, 2013

(54) Handle Assembly With Multi-Axial Adjustment

(71) Applicant: Reynolds E. Moulton, Brooklyn, NY (US)

(72) Inventor: Reynolds E. Moulton, Brooklyn, NY (US)

(73) Assignee: Egg Design, LLC, Brooklyn, NY (US)

(21) Appl. No.: 13/450,513

(22) Filed: Apr. 19, 2012

(51) Int. Cl. A61H 3/02; A61H 3/00; B25G 3/18; B25G 1/06; B25G 1/10

(52) U.S. Cl. 135/67; 81/489; 16/422

(57) ABSTRACT

A handle assembly with multi-axial adjustment is disclosed. The disclosed assembly provides for more ergonomic handling of various tools, particularly ambulatory assistance devices. In an exemplary embodiment, a splined coupling provides 360 degree adjustability about its axis. A housing unit provides an adjustable interface between the splined coupling and a handle component. A convex face of the housing unit is geared, and a concave face of the handle component is adapted to selectable engage with the housing unit at a variety of angels.

### CROSS REFERENCES TO RELATED APPLICATIONS

None.

### FIELD OF INVENTION

The technology relates to the field of adjustable handles for the ergonomic manipulation of tools, and has specific application to manipulation of ambulatory assistance tools.

### BACKGROUND

Using ambulatory devices (such as canes, walkers and crutches) places substantial forces on the user's wrists. At times, nearly all of the user's body weight will be supported through the arms and wrists.

Human wrists have not evolved to support such compressive, torsional and shear forces. Therefore handle design requires special attention to ergonomic details. These details include the natural angle between forearm and handle while grasping, and the available range of musculoskeletal angles for such grasp. The user's center of gravity should be carefully considered, as its locations differs between users.

Poor handle design leads to wrist strain, fatigue, repetitive stress and similar injuries. Poor handle design also reduces the accuracy of tool manipulation, and increases the likelihood of slipping between hand and handle. When the tool at issue is a mobility device, this hand-handle slipping can result in loss of balance, falling, and serious impact injury.

Furthermore, users of ambulatory devices apply and release forces to the handle cyclically with each step. This results in significant cyclical stresses in the wrist. Handle design should manage these stresses to reduce risk of discomfort and repetitive stress injury.

Handle assembly design requires ergonomic handle placement in relation to the arm, wrist and hand. Since human arms, wrists and hands come in a variety of sizes, there is a need for a handle assembly that can adjust to properly fit a range of people.

### SUMMARY

The disclosed technology provides for an improved handle assembly. Specifically, a handle assembly with a multi-axial adjustment mechanism that facilitates optimal handle placement. The available positions ergonomically map to the range of musculoskeletal movement of the human wrist. The handle assembly is especially useful for ambulatory devices where a substantial portion of the user's body weight is supported by the handle.

In one embodiment, a splined coupling is secured to the shaft of a tool. This allows for a plurality of adjustment options about the shaft's axis. Specifically, the inner splined face of the coupling is secured to the shaft of a tool, and the outer sleeve is integral to a housing unit. A first locking mechanism prevents accidental disengagement of the coupling during use.

A second adjustable joint extends from an outer face of the housing unit. This second adjustable joint provides handle position options in a plane orthogonal to the shaft's axis. A second locking mechanism prevents accidental disengagement of the second coupling during use.

In another embodiment, the multi-axial adjustment mechanism is an indexable ball joint. In this embodiment, two hemispheres are each secured to the shaft of a tool. A plurality of sockets are arranged on the inner face of each hemisphere. One end of the handle is secured to a sphere. A plurality of keys protrude from the outer face of this sphere, and are adapted to engage to the sockets of the hemisphere at a plurality of selectable arrangements. Once the appropriate angle is selected, a locking mechanism prevents accidental disengagement during use.

### BRIEF DESCRIPTION OF THE DRAWINGS

Various embodiments of the invention are disclosed in the following detailed description and accompanying drawings.

FIG. 1 illustrates a perspective view of the inner component of the splined coupling.

FIG. 2 illustrates a perspective view of the housing unit.

FIG. 3 illustrates a perspective view of the forked handle rod.

FIG. 4 illustrates a perspective view of the forked handle rod with ergonomic grip.

FIG. 5 illustrates a perspective view of the housing unit on a shaft

FIG. 6 illustrates an exploded view of the components.

FIG. 7 illustrates an assembled view of the multi-axial handle as attached to a shaft.

FIG. 8 Illustrates a handle core of alternative embodiment with ball joint adjustment mechanism.

FIG. 9 illustrates a ball joint embodiment with keyed handle sphere and socketed hemispheres.

### DETAILED DESCRIPTION AND PREFERRED EMBODIMENT

Introduction. The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

Overview. An exemplary embodiment includes: a coupling with an inner spline component and an outer sleeve component; a housing unit secured to the outer sleeve; and a handle component adjustably secured to the housing unit. The components of this embodiment are discussed below in detail.

The exemplary embodiment is part of an “ambulatory device.” An ambulatory device is a tool that assists in human walking such as a crutch, forearm crutch, underarm crutch, walker, cane, walking stick or similar device.

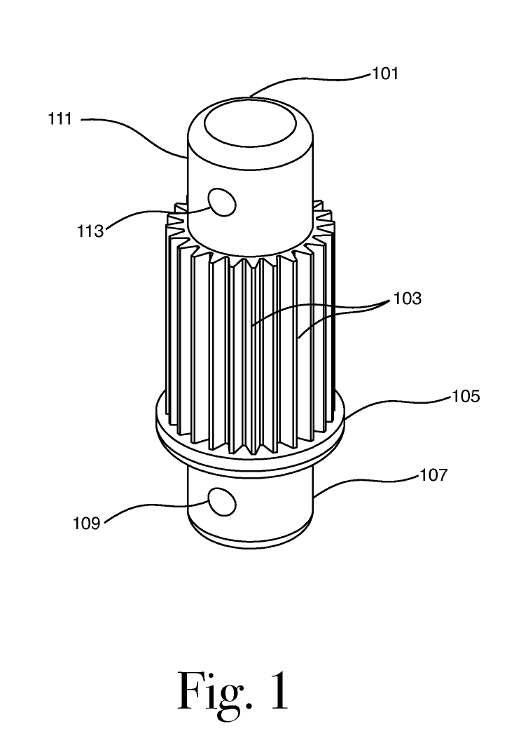

FIG. 1—Mounting component. FIG. 1 illustrates a perspective view of the mounting component 101 of the splined coupling. The mounting component (a) secures to the shaft of a tool, and (b) adjustably secures to an inner face of the housing unit. The mounting component is roughly cylindrical. A portion of its outer face is covered by a plurality of spline-like teeth 103 running parallel to its axis.

Splines are spaced finely enough to allow a multiple usable angles of adjustment, while retaining sufficient strength to withstand the torqueing forces of normal use. In an exemplary embodiment, the spline's pitch diameter is about 3 mm. In other embodiments, the “splines” may be a single key, or splines with a pitch as fine as 0.01 mm.

The splines may be manufactured from a high strength material such as titanium, or various steel alloys, including carbon steel, chromium steel, carbon chromium steel, or carbon manganese steel. Preferred materials are also corrosion resistance and capable of manufacture at relatively fine tolerances.

At a first end, the splines terminate at a ledge 105. A first cylindrical lip extends beyond the ledge 107. A socket 109 traverses the first lip, perpendicular to the axis.

The ledge impedes axial translation of the sleeve along the splines in one direction. The ledge resists forces applied by the user to the handle apparatus. The first cylindrical lip is adapted to securely engage to the first portion of the shaft of a tool. The socket is adapted to align with a socket on the shaft of a tool, and accept a locking fastener. In the exemplary embodiment, the fastener is a bolt or cap screw.

At a second end, a second cylindrical lip 111 extends beyond the splines 103. A socket 113 traverses the second lip, perpendicular to the axis. The second lip is adapted to securely engage to a second portion of the shaft of a tool.

In this embodiment, the tool is an ambulatory device such as a crutch, walker or similar mobility assistance device. Other embodiments may involve other tools that places forces on the wrist.

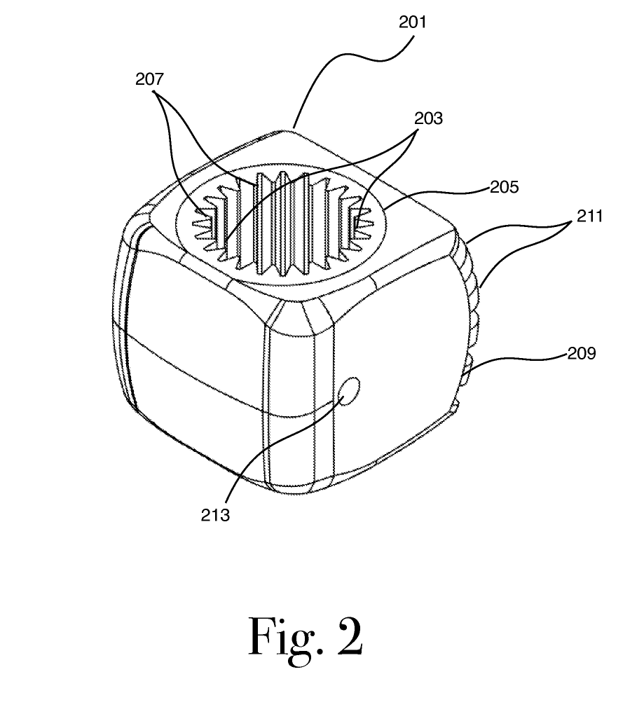

FIG. 2—Housing unit. The housing unit 201 of an exemplary embodiment is the interface between the mounting component 101 and the handle component 301.

The sleeve component 203 of the splined coupling 101, 201 is integral to the inner face of the housing unit 205. The sleeve component 203 is a cylinder with a plurality of axial teeth 207 on its inner face. These teeth 207 are engageable to the outer splined face 103 of the inner splined coupling component 101. The sleeve 203 may be engaged to the spline 103 at a plurality of angles. These angles of adjustment provide a first plane of adjustment (perpendicular to the splines 103) for the handle.

The housing unit includes a second adjustable interface, between itself and the handle component, creating a second axis of adjustability for the overall handle assembly.

An outer face 209 of the housing unit is convex. The convex face roughly describes a section of a cylinder. A plurality of teeth 211 protrude from this convex face 209. A socket 213 adapted to accept a pin transverses the housing unit 201, perpendicular to the spline axis, and concentric to the central axis of the cylinder section described the by housing unit's convex face 209. A “pin” is any fastener that may be used to engage a plurality components at a plurality of angles with respect to each other, about the axis of the fastener.

The housing unit is manufactured from a material selected for impact resistance, abrasion resistance, and high strength to weight ratio. Embodiments may be built from thermoplastics such as POM (polyoxymethylene), PA (polyamide) and PC (polycarbonate). In the preferred embodiment, the material is a polycarbonate reinforced with glass fiber. In other embodiments components may be manufactured from metals and alloys such as aluminum, anodized aluminum, magnesium, or titanium. The metals and alloys may be treated to improve abrasion resistance.

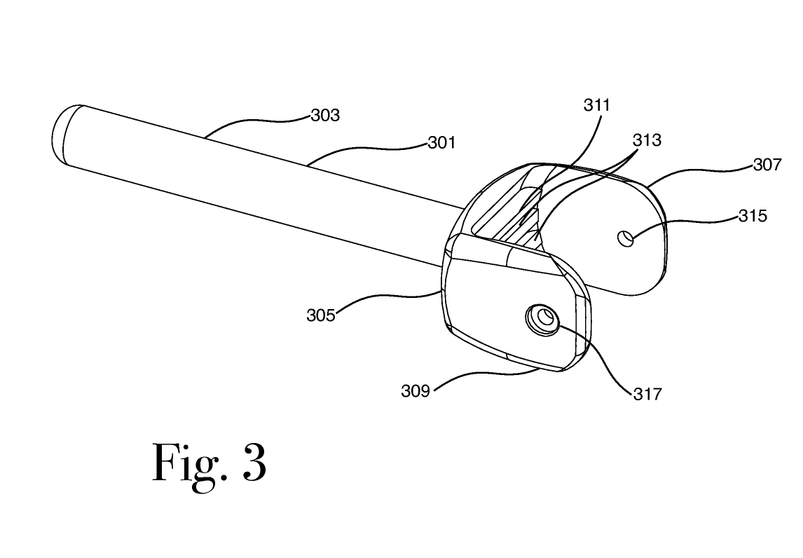

FIG. 3—Handle Component. The handle component 301 of an exemplary embodiment comprises a handle rod 303, and a bifurcated attachment end 305 with a plurality of attachment arms 307, 309. The attachment end 305 includes a concave face 311 situated between the arms 307, 309, and perpendicular to the handle rod 303.

A set of teeth 313 extend from this concave face 311. The teeth 313 are adapted to engage with the outer housing unit 201 teeth 211 at a plurality of positions.

A first and second arm 307, 309 of the attachment end each include a socket 315, 317 adapted to (a) accept a pin, and (b) align with the housing unit socket 213 when the arm is engaged to the housing unit, regardless of the selected angle of engagement.

In other embodiments, only a single attachment arm is required.

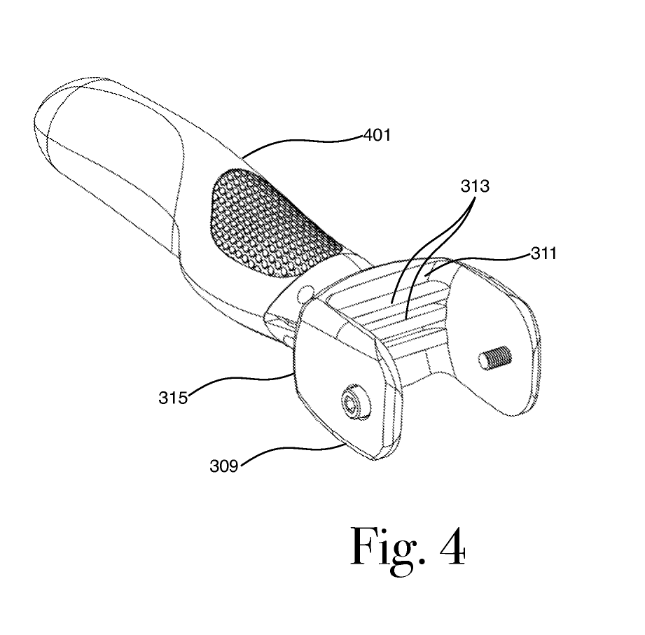

FIG. 4—Handle with Ergonomic Grip. FIG. 4 illustrates a forked handle rod 301 of an exemplary embodiment covered by an ergonomic grip 401. The grip material is a flexible material selected from a group consisting of neoprene, gel and Ethylene Vinyl Acetate (EVA) memory foam and wherein the elastic material is neoprene with spandex

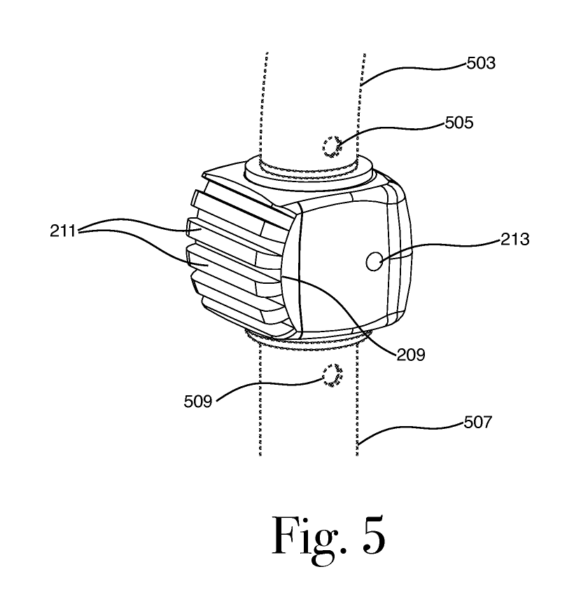

FIG. 5—Housing unit on Shaft. FIG. 5 illustrates an exemplary embodiment of the housing unit, as secured to the shaft of an arbitrary tool. The shaft of the tool is shown in dotted lines because it is not part of the emobidment.

A first portion of the shaft 503 has an inner diameter sized to securely engage a first lip of the inner spline. A socket 505 traverses the first portion of the shaft, and is adapted to (a) accept a pin, and (b) align with the socket 113 in the first lip 111 of the inner spline 101.

A second portion of the shaft 507 has an inner diameter sized to securely engage a second lip 107 of the inner spline. A socket 509 transverses the second portion of the shaft, and is adapted to (a) accept a bolt, and (b) align with the socket 109 in the inner spline's second lip 107.

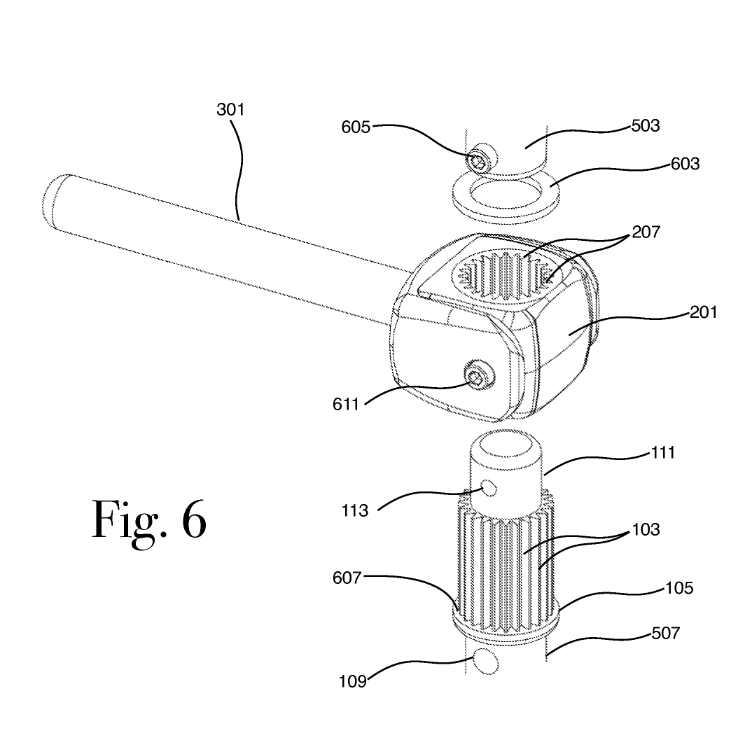

FIG. 6—Exploded View. FIG. 6 illustrates an exploded view of an exemplary embodiment, as attached to the shaft of a tool.

The second lip 107 of the inner spline is inserted into the shaft 507, and the sockets 109 are aligned. A fastener may be inserted through the sockets to prevent accidental disengagement.

The inner portion 101 of the first splined coupling is secured to a portion of the shaft 507. The internal splines 103 run parallel to the shaft's axis. The internal splines 103 are engageable to a set of external teeth 207 in the sleeve.

The housing unit 201 is inserted over the inner spline at one of a plurality of available angles. A washer 603 is placed over the first lip 111. A first portion of the shaft 503 is inserted over the first lip 111.

A ledge 105 prevents movement of the housing unit 201 along the axis of the splines below its upper face 607.

The socket 113 in first lip 111 is aligned to the socket 505 in the first portion of the shaft, and a fastener 605 is inserted. The fastener 605 prevents accidental disengagement of the splined coupling 101, 201.

A pin 611 is inserted through the two handle component arm sockets 315, 317 and through the housing unit socket 213. The handle 303, teeth 313 and pin become, essentially, a class 2 lever (that is, a lever arranged force, resistance, fulcrum). The pin 611 acts as both a fulcrum for the lever, and as a locking mechanism to prevent accidental disengagement between the housing unit 201 and the handle 301.

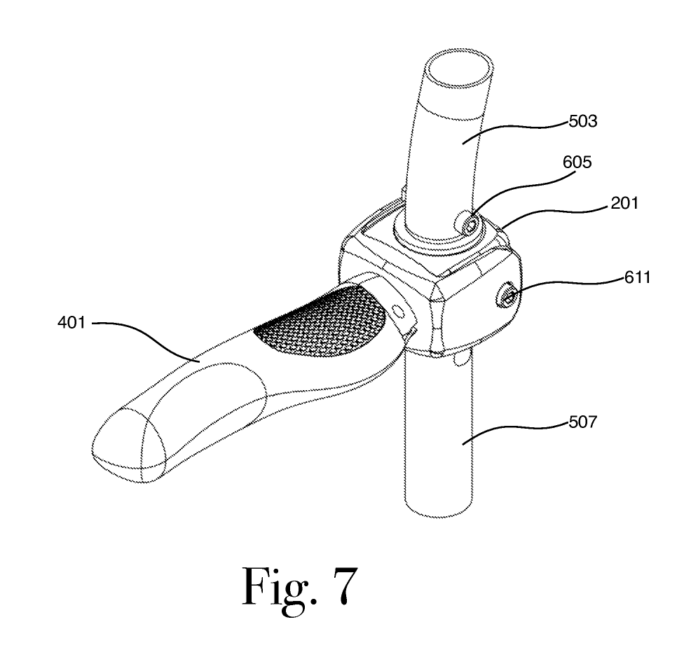

FIG. 7—Assembled View. FIG. 7 illustrates an assembled handle assembly of an exemplary embodiment. The adjustment teeth and splines are hidden, while the locking pins 605, 611 are easily accessible.

Alternative Ball Joint Embodiment. In another embodiment, the multi-axial adjustment mechanism is an indexable ball joint.

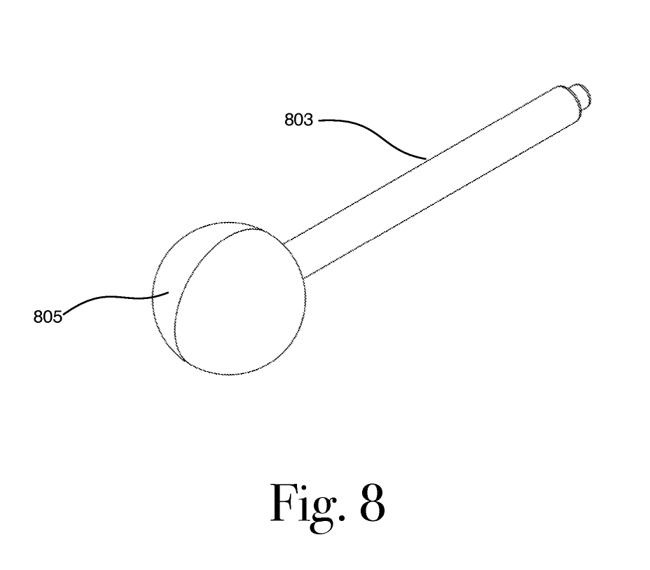

FIG. 8—Handle Core. FIG. 8 illustrates a perspective view of ball 805 and handle core 803 of a ball joint embodiment. Unlike the bifurcated end of the handle core 307, 309 in the previous embodiment, this handle core 803 ends in a sphere 805.

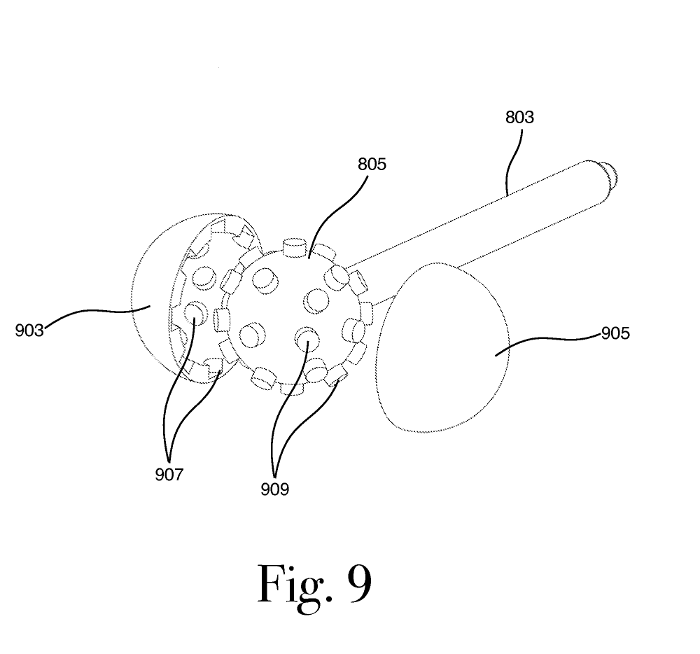

FIG. 9—Ball Joint with Keyed Sphere. FIG. 9 illustrates a ball joint embodiment with keyed sphere 805 and socketed hemispheres 903, 905.

In this embodiment, two hemispheres 903, 905 are each securable to the shaft of a tool. A plurality of sockets 907 are arranged on the inner face of each hemisphere 903, 905. One end of the handle 803 is secured to a sphere 805. A plurality of keys 909 protrude from the outer face of this sphere 805, and are adapted to engage to the sockets 907 of the hemispheres 903, 905 at a plurality of selectable arrangements. Once the appropriate angle is selected, a locking mechanism prevents accidental disengagement during use

Although embodiments have been described in detail, the invention is not limited to the details provided. There are many alternative ways of implementing the invention. The disclosed embodiments are illustrative, not restrictive.

What is claimed is:

1. A handle assembly adapted for multi-axial adjustment, comprising:
a mounting component, a housing unit, and a handle component, wherein
a. a splined face of the mounting component is adjustably engageable to a plurality of teeth on an inner face of the housing unit;
b. an externally geared convex second face of the housing unit is adjustably engageable to a plurality of teeth on a concave first face of the handle component; and wherein
c. the handle component includes an arm removably pinnable to the housing unit.

2. The handle assembly of claim 1 wherein the arm of the handle component is pinnable to the housing unit at the central axis of the curve described by the housing unit's convex face.

3. The handle assembly of claim 1 wherein the mounting component is mountable to a shaft such that the mounting component is concentric with the axis of the shaft.

4. The handle assembly of claim 1 wherein an end of the handle component includes a second arm pinnable to the mounting component at the central axis of the curve of the second face.

5. The handle assembly of claim 1, wherein the splines are involute splines.

6. The handle assembly of claim 1 wherein the arm of the handle component is removably pinnable to the housing unit with a cap screw.

7. The handle assembly of claim 1 wherein,
a. the housing unit is secured to the mounting component, and wherein
b. a fastener inserted through a lip of the mounting component prevents translation of the housing unit along the axis of the splines.

8. The handle assembly of claim 1, further comprising a plurality of sockets along the axis of the mounting component, and wherein a degree of longitudinal adjustability is provided by inserting a pin through the coupling and mounting component at the selected socket.

9. The handle assembly of claim 1, wherein the splines are manufactured from a metal selected from the group of titanium, carbon steel, chromium steel, carbon chromium steel, and carbon manganese steel.

10. The handle assembly of claim 1, wherein the housing unit is manufactured from a thermoplastic selected from the group of POM (polyoxymethylene), PA (polyamide) and PC (polycarbonate) and polycarbonate reinforced with glass fiber.

11. An ambulatory device with adjustable handle, comprising:
a shaft, a mounting component, a housing unit, and a handle component, wherein
a. the mounting component is secured to the shaft,
b. a splined face of the mounting component is adjustably engaged to a plurality of teeth on an inner face of the housing unit;
c. an externally geared convex second face of the housing unit is adjustably engaged to a plurality of teeth on a concave first face of the handle component; and wherein
d. the handle component includes an arm removably pinnable to the housing unit.

12. The handle assembly of claim 11 wherein the handle rod is covered in an ergonomic grip made of a flexible material selected from a group consisting of neoprene, neoprene with spandex, gel, and Ethylene Vinyl Acetate (EVA) memory foam.

13. A handle assembly with multi-axial adjustment, comprising:
a. a multi-axial adjustment means securable to a tool at a plurality of angles about a first axis, and
b. a handle adjustably securable to the multi-axial adjustment means at a plurality of angles about a second axis.

14. The handle assembly of claim 13 wherein,
a. the available adjustment angles map to the range of musculoskeletal movement of the human wrist.

15. The ambulatory device of claim 13 wherein, the shaft of separates into a first and second component at the adjustment mechanism.

16. The ambulatory device of claim 13 wherein the multi-axial adjustment means is manufactured from a thermoplastic selected from the group of POM (polyoxymethylene), PA (polyamide) and PC (polycarbonate) and polycarbonate reinforced with glass fiber.

17. A handle assembly adapted for multi-axial adjustment, comprising:
a mounting component and a handle component, wherein
a. a first hemisphere of the mounting component is securable to a first portion of a tool, and a second hemisphere of the mounting component is securable to a second portion of a tool, and a plurality of sockets are dispersed about the inner face of each hemisphere,
b. a first end of the handle component is a sphere, and wherein a plurality of keys extend from the sphere, and wherein the keys are adapted to engage the sockets at a plurality of available angles about multiple axis, and

18. The handle assembly of claim 17 wherein the handle assembly is mounted on the shaft of an ambulatory assistance device.

19. The handle assembly of claim 17 wherein an end of the handle component is a rod of sufficient length to comfortably accept a human hand.

20. The handle assembly of claim 17 wherein the handle rod is covered in an ergonomic grip made of a flexible material selected from a group consisting of neoprene, neoprene with spandex, gel, and Ethylene Vinyl Acetate (EVA) memory foam.
